(19) United States
(12) Patent Application Publication
(10) Pub. No.: US 2024/0423432 A1
(43) Pub. Date: Dec. 26, 2024

(54) ROBOT CLEANER

(71) Applicant: Samsung Electronics Co., Ltd., Suwon-si (KR)

(72) Inventors: Hyungmin SON, Suwon-si (KR); Yongsoo KWAK, Suwon-si (KR); Euisik KIM, Suwon-si (KR); Sajid SADI, Mountain View, CA (US); Leo JUN, Suwon-si (KR)

(21) Appl. No.: 18/825,508

(22) Filed: Sep. 5, 2024

Related U.S. Application Data
(63) Continuation of application No. PCT/KR2023/002656, filed on Feb. 24, 2023.

(30) Foreign Application Priority Data
Mar. 7, 2022 (KR) 10-2022-0029007

(51) Int. Cl. A47L 9/24; A47L 5/12; B25J 9/00

(52) U.S. Cl. CPC A47L 9/24; A47L 5/12; B25J 9/0003; A47L 2201/04

(57) ABSTRACT

A robot cleaner is provided. The robot cleaner includes a plurality of bending tubes which are integrally connected along a longitudinal direction thereof and each of which is closed at one end and changes in volume depending on pressure in an internal space thereof, a pump device that adjusts the pressure in the internal space of each of the plurality of bending tubes, a head part disposed at one end of the plurality of bending tubes to suck air, a dust collection device that separates dust from the air sucked through the head part, and a dust collection tube that communicates the head part and the dust collection device.

### CROSS-REFERENCE TO RELATED APPLICATION(S)

This application is a continuation application, claiming priority under § 365(c), of an International application No. PCT/KR2023/002656, filed on Feb. 24, 2023, which is based on and claims the benefit of a Korean patent application number 10-2022-0029007, filed on Mar. 7, 2022, in the Korean Intellectual Property Office, the disclosure of which is incorporated by reference herein in its entirety.

### BACKGROUND

### 1. Field

The disclosure relates to a robot cleaner. More particularly, the disclosure relates to a robot cleaner that can clean various types of spaces using a head part supported by a plurality of flexible bending tubes and having a high degree of freedom.

### 2. Description of Related Art

Vacuum cleaners of the related art are divided into an upright type that a person carries and cleans by hand, a large-capacity canister type, and a robot cleaner based on an autonomous moving object. With the advancement of self-location recognition technology and suction power, attractive technologies, such as autonomous cleaning while the user is out and autonomous return to the docking station to recharge the battery when the battery is low have been developed and applied to the robot cleaner. Therefore, the market for robot cleaners is gradually expanding.

However, because existing robot cleaners have a rigid case and a large suction structure, they cause significant damage when they collide with furniture or walls while traveling, and it is difficult to access narrow and deep spaces. In addition, existing robot cleaners have the problem that they can only clean the floor surface and cannot clean the upper space.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a robot cleaner in which a head part supported by a plurality of flexible bending tubes has a high degree of freedom and can clean various types of spaces.

Additional aspects will be set forth in part in the description which follows and, in part, will be apparent from the description, or may be learned by practice of the presented embodiments.

In accordance with an aspect of the disclosure, a robot cleaner is provided. The robot cleaner includes a plurality of bending tubes which are integrally connected along a longitudinal direction thereof and each of which is closed at one end and changes in volume depending on pressure in an internal space thereof, a pump device that adjusts the pressure in the internal space of each of the plurality of bending tubes, a head part disposed at one end of the plurality of bending tubes to suck air, a dust collection device that separates dust from the air sucked through the head part, and a dust collection tube that communicates the head part and the dust collection device.

The robot cleaner further includes a main body accommodating the pump device and the dust collection device, a robot arm connected to the main body and supporting the plurality of bending tubes and the dust collection tube, a driving device to move the robot arm, and a camera to capture images of a surrounding environment of the robot cleaner, a processor that identifies a cleaning area based on the images captured by the camera and control the driving device to place the head part in the identified cleaning area.

The robot cleaner further includes a mapping sensor to detect the cleaning area around the head part, and a processor that determines a motion of the plurality of bending tubes based on a signal received from the mapping sensor and controls the pump device to bend the plurality of bending tubes in the determined motion.

The mapping sensor is disposed on the head part and detect a distance between the head part and an obstacle disposed in the cleaning area, and the processor determines the motion of the plurality of bending tubes based on the distance to the obstacle detected by the mapping sensor.

The mapping sensor includes a plurality of mapping sensors disposed on a left surface, a right surface, an upper surface, and a lower surface of the head part, respectively.

The robot cleaner further includes a main body accommodating the pump device and the dust collection device, and a robot arm rotatably connected to the main body and supporting the plurality of bending tubes and the dust collection tube.

The robot arm includes a main frame including one end rotatably connected to the main body, and a first extension frame that supports the plurality of bending tubes and is connected to the main frame so as to be movable along a longitudinal direction of the main frame.

The first extension frame is slidingly connected to an upper surface of the main frame and disposed below the plurality of bending tubes to support the plurality of bending tubes upward.

The robot cleaner further includes a first extension device that moves the first extension frame along the longitudinal direction of the main frame.

The first extension device includes a first motor connected to the first extension frame, a pinion gear rotated by the first motor, and a rack gear engaged with the pinion gear and disposed on the upper surface of the main frame.

The robot cleaner further includes a rail disposed on the upper surface of the main frame parallel to the longitudinal direction of the main frame, a wire that provides power to the first extension device and is electrically connected to a rear end of the rail, and a terminal electrically connecting the rail and the first extension device and moving integrally with the first extension frame.

The terminal includes a contact terminal having a lower surface in contact with the rail, and an elastic member having one end connected to an upper surface of the contact terminal and another end connected to the first extension frame.

The robot arm further includes a second extension frame that supports another end of the plurality of bending tubes and is connected to the first extension frame so as to be movable along a longitudinal direction of the first extension frame.

The robot cleaner further includes a plurality of connection tubes that communicates the pump device with the plurality of bending tubes, respectively, wherein the second extension frame is slidingly connected to an upper surface of the first extension frame, supports the another end of the plurality of bending tubes, and includes a plurality of holes through which the plurality of connection tubes each pass.

The robot cleaner further includes a second extension device that moves the second extension frame along the longitudinal direction of the first extension frame.

The second extension device includes a second motor connected to the first extension frame, and a belt disposed on the upper surface of the first extension frame, supporting the second extension frame, and being rotated by the second motor.

The robot cleaner further includes a plurality of connection tubes that communicates the pump device with other ends of the plurality of bending tubes, respectively, and a drum rotatably connected to one end of the main frame and including a plurality of ports that communicates an inner circumferential surface of the drum with an outer circumferential surface of the drum and through which the plurality of connection tubes each pass, wherein one sections of the connection tubes pass through the ports and wrap around the outer circumferential surface of the drum.

The drum includes a plurality of grooves formed on an outer circumferential surface along an outer circumferential direction and around which the plurality of connection tubes are wound, respectively.

The plurality of bending tubes is disposed to circumscribe each other, and the dust collection tube is disposed in a space between the plurality of bending tubes.

The dust collection tube is disposed on an outside of the plurality of bending tubes along a longitudinal direction of the plurality of bending tubes.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a perspective view of a robot cleaner according to an embodiment of the disclosure;

FIG. 2 is an exploded perspective view of a robot cleaner of FIG. 1 according to an embodiment of the disclosure;

FIG. 3 is a view illustrating a plurality of bending tubes being bent in various directions according to an embodiment of the disclosure;

FIGS. 4A and 4B are cross-sectional views illustrating a structure of a plurality of bending tubes and a dust collection tube according to an embodiment of the disclosure;

FIG. 5 is a functional block diagram of a robot cleaner according to an embodiment of the disclosure;

FIG. 6 is a view illustrating a state in which a robot arm is rotated from a main body according to an embodiment of the disclosure;

FIG. 7 is a view illustrating a state in which an extension frame is extended from a main body according to an embodiment of the disclosure;

FIG. 8 is a view illustrating a structure of first and second extension devices according to an embodiment of the disclosure;

FIG. 9 is a top view of a main frame according to an embodiment of the disclosure;

FIG. 10 is a view illustrating a terminal structure for supplying power to a first extension device according to an embodiment of the disclosure;

FIGS. 11 and 12 are an exploded perspective view and a perspective view of a drum part, respectively, according to various embodiments of the disclosure;

FIG. 13 is a view schematically illustrating a structure of a pump device according to an embodiment of the disclosure;

FIGS. 14A, 14B, 14C, and 14D are views illustrating motions of a robot cleaner cleaning various spaces according to an embodiment of the disclosure; and

FIGS. 15A and 15B are perspective views of a head part according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In this disclosure, the terms, such as “have”, “may have”, “include” or “may include” refer to a presence of the corresponding features (e.g., a numerical value, function, operation, or component, such as a part), and does not preclude a presence of additional features.

In the disclosure, components required for the description of each embodiment of the disclosure are described and thus, the embodiment is not necessarily limited thereto. Accordingly, some components may be changed or omitted and other components may be added. In addition, components may be disposed and arranged in different independent devices.

Further, the embodiments of the disclosure will be described with reference to the accompanying drawings and the contents described in the accompanying drawings, but the disclosure is not limited or limited by the embodiments.

Hereinafter, the disclosure will be described with reference to the accompanying drawings.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

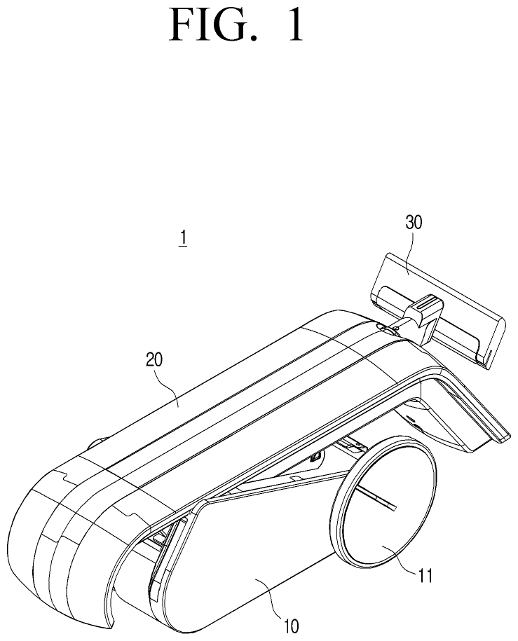

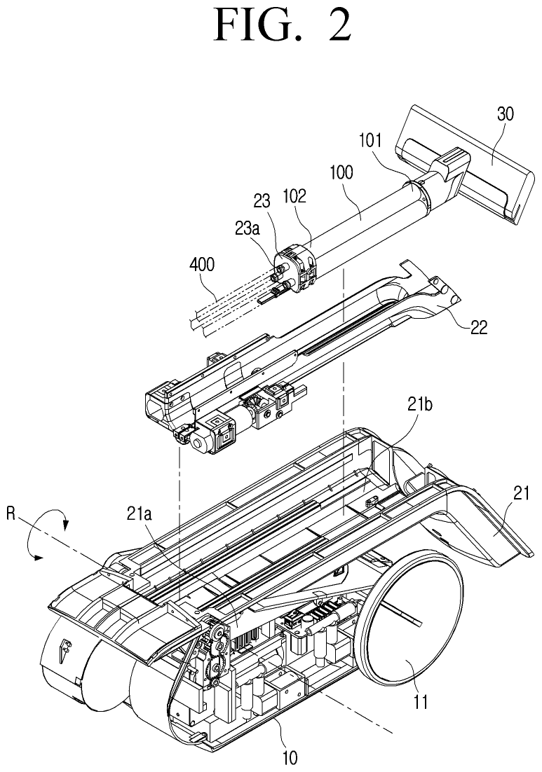

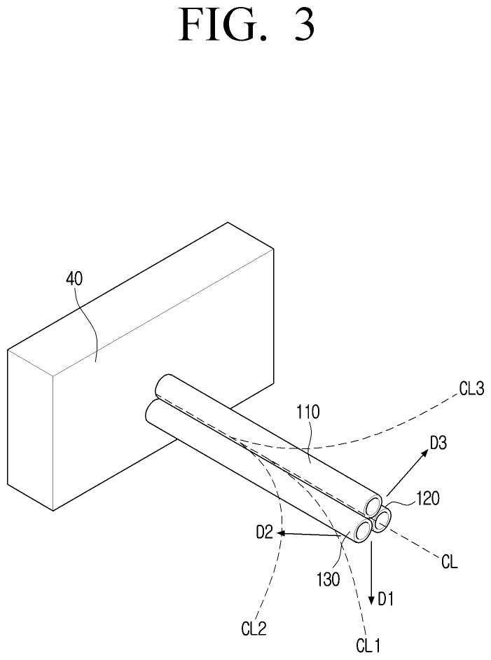

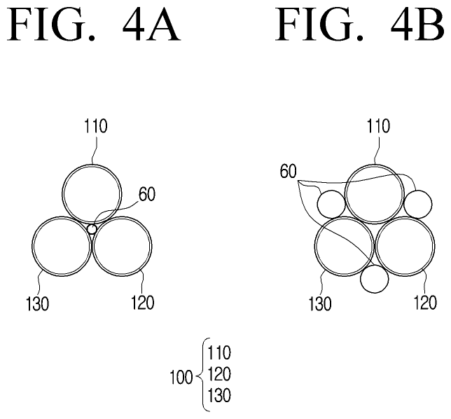

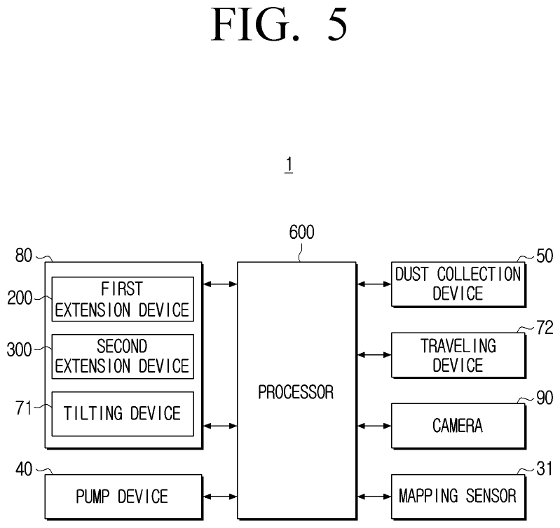

FIG. 1 is a perspective view of a robot cleaner according to an embodiment of the disclosure. FIG. 2 is an exploded perspective view of a robot cleaner of FIG. 1 according to an embodiment of the disclosure. FIG. 3 is a view illustrating a plurality of bending tubes being bent in various directions according to an embodiment of the disclosure. FIGS. 4A and 4B are cross-sectional views illustrating the structure of a plurality of bending tubes and a dust collection tube according to an embodiment of the disclosure. FIG. 5 is a functional block diagram of a robot cleaner according to an embodiment of the disclosure.

Referring to FIGS. 1 to 5, a robot cleaner according to an embodiment of the disclosure may include a main body 10, a robot arm 20, a head part 30, a pump device 40, a dust collection device 50, a dust collection tube 60, and a plurality of bending tubes 100.

The main body 10 may accommodate a plurality of electronic devices necessary for the operation of the robot cleaner 1. Wheels 11 may be rotatably connected to both side surfaces of the main body 10. A traveling device 72 accommodated in the main body 10 may rotate the wheels 11 so that the robot cleaner 1 moves to a preset position or along a preset path.

The robot arm 20 is disposed on the upper side of the main body 10 and may be rotatably connected to the main body 10. The rear end of the robot arm 20 may be connected to the main body 10 to rotate around the horizontal rotation axis R. Accordingly, the front end of the robot arm 20 may ascend or descend.

The robot arm 20 may support the head part 30, the dust collection tube 60, and the plurality of bending tubes 100. Accordingly, as the robot arm 20 ascend or descend, the head part 30 may move to a target cleaning area.

The robot arm 20 may include a main frame 21, a first extension frame 22, and a second extension frame 23. The first extension frame 22 may be stacked on the main frame 21, and the second extension frame 23 may be stacked on the first extension frame 22.

One end 21a of the main frame 21 may be rotatably connected to the main body 10. The one end 21a of the main frame 21 may refer to the rear end of the robot arm 20.

The first extension frame 22 may be disposed on the upper surface 21b of the main frame 21 to be slidable in the longitudinal direction of the main frame 21. In addition, the second extension frame 23 may be disposed on the upper surface of the first extension frame 22 to be slidable in the longitudinal direction of the first extension frame 22. Accordingly, the overall length of the robot arm 20 may be increased, and the head part 30 located at the front end of the robot arm 20 may be moved to various target cleaning areas.

The robot cleaner 1 according to an embodiment of the disclosure may further include a plurality of connection tubes 400. The plurality of connection tubes 400 may allow the pump device 40 to communicate with the plurality of bending tubes 100, respectively. The second extension frame 23 may be slidably connected to the upper surface 21b of the first extension frame 22, support the other end 102 of the plurality of bending tubes 100, and include a plurality of holes 23a through which the plurality of connection tubes 400 pass respectively.

The head part 30 may be disposed at one end 101 of the plurality of bending tubes 100 and may suck air. Dust contained in the air sucked through the head part 30 may be separated by the dust collection device 50, which will be described later. The head part 30 may have a lower surface on which an air inlet is formed and a long shape left and right. However, the shape of the head part 30 is not limited thereto.

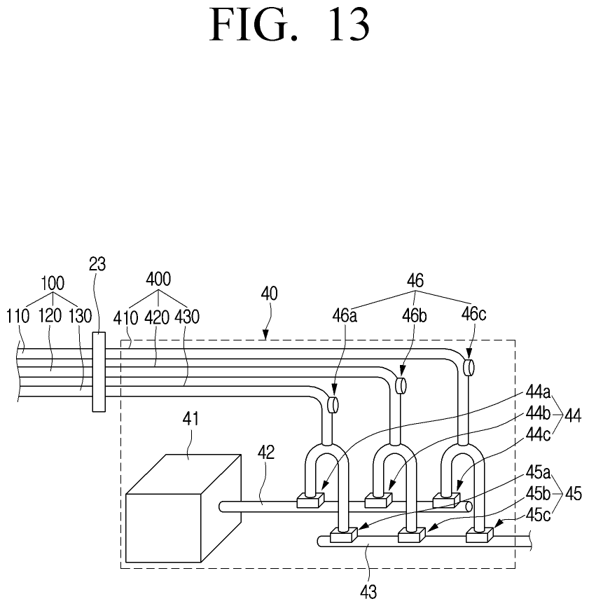

The pump device 40 may adjust the pressure of the internal space of each of the plurality of bending tubes 100. The pump device 40 may adjust the pressure of the internal spaces of the plurality of bending tubes 100 to be different from each other. The pump device 40 may adjust the pressure of the internal space of each of the plurality of bending tubes 100 by introducing air into or expelling air from the internal space of each of the plurality of bending tubes 100. The structure of the pump device 40 will be described with reference to FIG. 13.

The dust collection device 50 may separate dust from air sucked through the head part 30. The dust collection device 50 may be accommodated inside the main body 10. The dust collection device 50 may include a fan that generates suction force and a filter that separates dust from the air. The dust collection device 50 may be a cyclone dust collection device. The air drawn into the dust collection device 50 rotates, and the air containing dust may be separated into clean air and dust by the dust collection device 50.

The dust collection tube 60 may allow the head part 30 to communicate with the dust collection device 50. External air sucked through the head part 30 may be drawn into the inside of the dust collection tube 60 and moved to the dust collection device 50 through the dust collection tube 60. The dust collection tube 60 may be formed of a flexible material.

The dust collection tube 60 may be arranged in parallel with the plurality of bending tubes 100 and include one end connected to the head part 30 and the other end connected to the dust collection device 50.

One end 101 of each of the plurality of bending tubes 100 may be closed and the other end 102 of each of the plurality of bending tubes 100 may be open. The volume of each of the plurality of bending tubes 100 may vary depending on the pressure of the internal space thereof. The plurality of bending tubes 100 may be integrally connected along the longitudinal direction.

In other words, each of the plurality of bending tubes 100 has one end 101 closed and is made of a flexible material, so that the volume may vary depending on the pressure of the internal space. The plurality of bending tubes 100 may be formed of silicon, but the material of the bending tubes 100 is not limited thereto. The plurality of bending tubes 100 may be formed of any material as long as it is elastic and ductile.

Each of the plurality of bending tubes 100 may have the internal space formed along the longitudinal direction. Because one end 101 of each of the plurality of bending tubes 100 is closed, the volume of each of the plurality of bending tubes 100 may vary depending on the pressure of the internal space.

The other end of each of the plurality of bending tubes 100 opposite to one end 101 may be fixed to the pump device 40. The plurality of bending tubes 100 may extend or be freely bent in a specific direction based on a point fixed to the pump device 40.

The plurality of bending tubes 100 may be bent into various shapes according to changes in the volume of each of the plurality of bending tubes 100. For example, the plurality of bending tubes 100 may include a first bending tube 110, a second bending tube 120, and a third bending tube 130.

Referring to FIG. 3, the plurality of bending tubes 100 may be stretched or bent in various directions while one point of each of the plurality of bending tubes 100 is fixed to the pump device 40.

For example, when the first to third bending tubes 110, 120, and 130 increase in volume at the same rate, the plurality of bending tubes 100 may be extended along the center line CL.

When the first bending tube 110 has a larger volume than the second and third bending tubes 120 and 130, the first bending tube 110 may press the second and third bending tubes 120 and 130 in the D1 direction. Accordingly, the plurality of bending tubes 100 may be bent so that the center line thereof changes from CL to CL1.

When the second bending tube 120 has a larger volume than the first and third bending tubes 110 and 130, the second bending tube 120 may press the first and third bending tubes 110 and 130 in the D2 direction. Accordingly, the plurality of bending tubes 100 may be bent so that the center line thereof changes from CL to CL2.

In addition, when the third bending tube 130 has a larger volume than the first and second bending tubes 110 and 120, the third bending tube 130 may press the first and second bending tubes 110 and 120 in the D3 direction. Accordingly, the plurality of bending tubes 100 may be bent so that the center line thereof changes from CL to CL3.

For example, the plurality of bending tubes 100 may have three degrees of freedom for rotational movement and one degree of freedom for translational movement. Accordingly, the plurality of bending tubes 100 may be stretched or bent in various shapes so that one end thereof is easily positioned in various positions.

Accordingly, the head part 30 of the robot cleaner 1 according to an embodiment of the disclosure is supported by the plurality of bending tubes 100 formed of a soft material, so that the user may use the robot cleaner 1 safely. In addition, for the high degree of freedom of the head part 30, a complex link structure and a high-specification motor are not used, and it is implemented with the plurality of bending tubes 100 and the pump device 40, so it may be manufactured with a low manufacturing cost and a simple structure.

Referring to FIG. 4A, the plurality of bending tubes 100 may be arranged to circumscribe each other, and the dust collection tube 60 may be arranged in the space between the pluralities of bending tubes 100.

The plurality of bending tubes 100 may include first to third bending tubes 110, 120, and 130, and the cross-sections of the first to third bending tubes 110, 120, and 130 are circular and circumscribe each other. In this case, the dust collection tube 60 may be disposed in the space between the first to third bending tubes 110, 120, and 130 circumscribed to each other. Accordingly, the dust collection tube 60 and the plurality of bending tubes 100 may have a compact appearance.

Referring to FIG. 4B, the dust collection tube 60 may be disposed on the outside of the plurality of bending tubes 100 along the longitudinal direction of the plurality of bending tubes 100. The dust collection tube 60 may include a plurality of dust collection tubes which are disposed outside the first to third bending tubes 110, 120, and 130. For example, the dust collection tube 60 may include three dust collection tubes, and the three dust collection tubes may be arranged to circumscribe the adjacent bending tubes 100, respectively.

The cross-sectional area of the dust collection tube 60 may be formed to be sufficiently large regardless of the size of the bending tube 100. Accordingly, a greater flow rate of air may be sucked through the dust collection tube 60.

The robot cleaner 1 according to an embodiment of the disclosure may further include a driving device 80, a camera 90, and a processor 600. The driving device 80 may move the robot arm 20. The driving device 80 may include a first extension device 200, a second extension device 300, and a tilting device 71. For example, the driving device 80 may rotate or extend the robot arm 20.

The camera 90 may capture images of the surrounding environment of the robot cleaner 1. The processor 600 may identify a cleaning area based on the images captured by the camera 90, and control the driving device 80 so that the head part 30 is placed in the identified cleaning area. The camera 90 may be a Lidar sensor.

The processor 600 may include one or more of a central processing unit (CPU), an application processor (AP), or a communication processor (CP). The processor 600 may be a micro control unit (MCU).

The processor 600 may control hardware or software components connected to the processor 600 by running an operating system or application program, and may perform various data processing and calculations. In addition, the processor 600 may load and process commands or data received from at least one of the other components into volatile memory and store various data in non-volatile memory.

The processor 600 may recognize and classify a cleaning area into which the head part 30 can enter within the space based on the image signal received from the camera 90 disposed on the main body 10.

The processor 600 may generate a set data form of continuous point data from the point cloud data received from the camera 90, and recognize the space as an area of lines and surfaces through clusters of the set data, thereby recognizing and distinguishing the cleaning area into which the head part 30 can enter.

Thereafter, after the head part 30 enters the cleaning area, the processor 600 may recognize the size of the cleaning area through a mapping sensor 31 disposed on the head part 30.

The robot cleaner 1 may further include the mapping sensor 31 that detects the cleaning area around the head part 30. The mapping sensor 31 may be disposed on at least one of the main body 10, the robot arm 20, and the head part 30.

The mapping sensor 31 may be any one of a Lidar sensor, a camera sensor, and a distance sensor, but the type of the mapping sensor 31 is not limited thereto. The mapping sensor 31 may be various types of sensors capable of mapping the space of the cleaning area.

The mapping sensor 31 may detect the size of the cleaning area, the locations of obstacles placed within the cleaning area, or the like. The processor 600 may form a map of the cleaning area based on the spatial information of the cleaning area received from the mapping sensor 31. In addition, the processor 600 may determine the motion of the plurality of bending tubes 100 based on the signal received from the mapping sensor 31, and control the pump device 40 so that the plurality of bending tubes 100 are bent in the determined motion.

For example, the mapping sensor 31 may be disposed on the head part 30 and detect a distance between the head part 30 and an obstacle located in the cleaning area. At this time, the processor 600 may determine the motion of the plurality of bending tubes 100 based on the distance to the obstacle detected by the mapping sensor 31.

The robot cleaner 1 may further include the mapping sensor 31 disposed on the head part 30 to detect the distance between the head part 30 and an obstacle. The processor 600 may determine the motion of the plurality of bending tubes 100 based on the distance to the obstacle detected by the mapping sensor 31, and control the pump device 40 so that the plurality of bending tubes 100 are bent in the determined motion.

Accordingly, the cleaning radius of the head part 30 entering the cleaning area may be determined according to the results measured through the mapping sensor 31, and the pump device 40 may be controlled so that the plurality of bending tubes 100 is bent in the determined motion.

In this way, the space is sensed in order from the large space to the small space, and the head part 30 supported by the soft and flexible bending tubes 100 enters the cleaning area to suck dust in the cleaning area through various joint movements according to the shape and area of the space.

In addition, the robot cleaner 1 may use the tilting structure and extension structure of the robot arm 20 to clean spaces where the head part 30 is difficult to enter, such as corners of the floor or around the legs of a chair or table and a space located above the main body 10, such as the upper surface of the table.

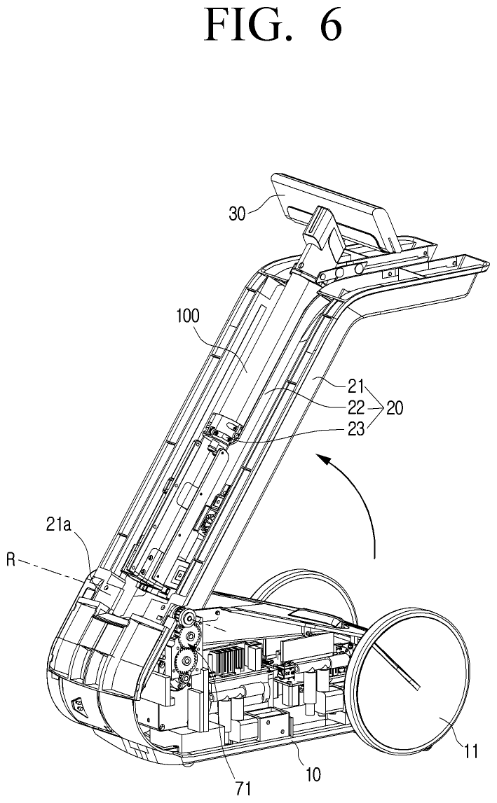

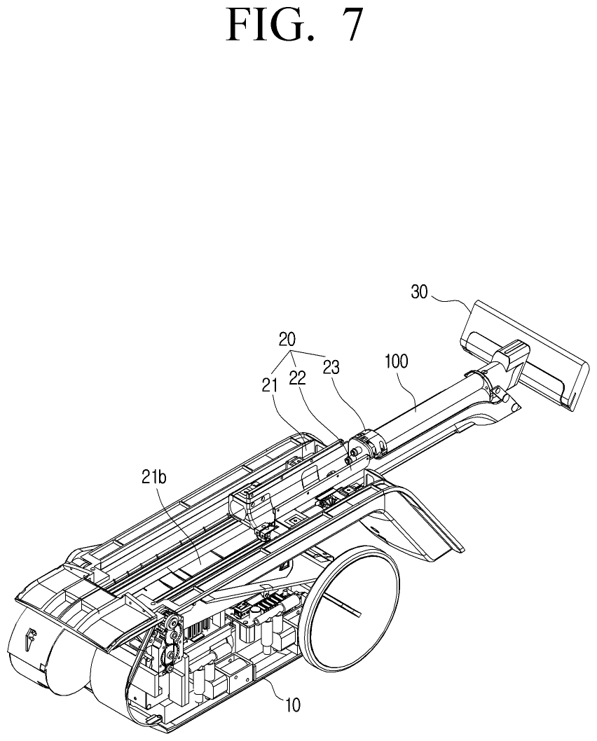

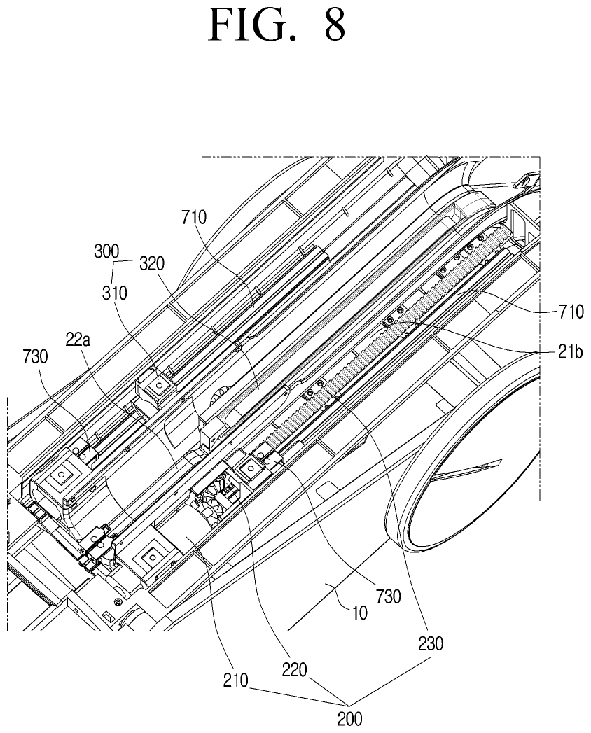

FIG. 6 is a view illustrating a state in which a robot arm is rotated from a main body according to an embodiment of the disclosure. FIG. 7 is a view illustrating a state in which an extension frame is extended from a main body according to an embodiment of the disclosure. FIG. 8 is a view illustrating a structure of first and second extension devices according to an embodiment of the disclosure.

Referring to FIGS. 6 to 8, the robot cleaner 1 according to an embodiment of the disclosure may further include a main body 10 and a robot arm 20. The main body 10 may accommodate the pump device 40 and the dust collection device 50. The robot arm 20 is rotatably connected to the main body 10, and may support the plurality of bending tubes 100 and the dust collection tube 60.

The robot cleaner 1 may include a tilting device 71 that rotates the robot arm 20 away from the main body 10 or closer to the main body 10. The tilting device 71 may include a motor and a gear part.

When the tilting device 71 rotates the rear end of the robot arm 20, the front end of the robot arm 20 rises, and the head part 30 may move to a cleaning area located above the main body 10.

The robot arm 20 may include a main frame 21 and a first extension frame 22. The main frame 21 may include one end 21a rotatably connected to the main body 10. The first extension frame 22 supports the plurality of bending tubes 100 and may be connected to the main frame 21 to be movable along the longitudinal direction of the main frame 21.

When the first extension frame 22 moves in a direction away from the main frame 21, the overall length of the robot arm 20 increases, and the head part 30 disposed at the front end of the robot arm 20 may move away from the main body 10.

The first extension frame 22 may be slidably connected to the upper surface 21b of the main frame 21, and may be disposed below the plurality of bending tubes 100 to support the plurality of bending tubes 100 upward. The first extension frame 22 may have a “U” shaped cross-section.

The first extension frame 22 may stably support the plurality of bending tubes 100 so that the plurality of bending tubes 100 do not sag downward.

The robot cleaner 1 may further include a first extension device 200 that moves the first extension frame 22 along the longitudinal direction of the main frame 21.

Accordingly, when the distance from the main body 10 to the cleaning area is long or the cleaning area is a narrow space into which the main body 10 cannot enter, the first extension device 200 may increase the overall length of the robot arm 20 by advancing the first extension frame 22 in a direction away from the main frame 21. Therefore, the head part 30 disposed at the front end of the robot arm 20 may be located in various cleaning areas.

The first extension device 200 may include a first motor 210, a pinion gear 220, and a rack gear 230. The first motor 210 may be connected to the first extension frame 22. The pinion gear 220 may be rotated by the first motor 210. The rack gear 230 may engage with the pinion gear 220 and may be disposed on the upper surface 21b of the main frame 21.

The first motor 210 and the pinion gear 220 may move together with the first extension frame 22, and the rack gear 230 may be fixedly disposed on the upper surface 21b of the main frame 21. When the first motor 210 rotates the pinion gear 220 engaged with the rack gear 230, the first extension frame 22, the first motor 210, and the pinion gear 220 may move forward in a direction away from the main frame 21.

The robot arm 20 may further include a second extension frame 23. The second extension frame 23 may support the other end 102 of the plurality of bending tubes 100, and may be connected to the first extension frame 22 to be movable along the longitudinal direction of the first extension frame 22.

The second extension frame 23 may be a bending center of the plurality of bending tubes 100. For example, the plurality of bending tubes 100 may be bent to the left, right, up, or down around the other end 102.

The robot cleaner 1 according to an embodiment of the disclosure may further include a second extension device 300 that moves the second extension frame 23 along the longitudinal direction of the first extension frame 22.

Accordingly, when the distance from the main body 10 to the cleaning area is long or the cleaning area is a narrow space into which the main body 10 cannot enter, the second extension device 300 may increase the overall length of the robot arm 20 by advancing the second extension frame 23 in a direction away from the first extension frame 22. Therefore, the head part 30 disposed at the front end of the robot arm 20 may be located in various cleaning areas.

The second extension device 300 may include a second motor 310 and a belt 320. The second motor 310 may be disposed on the first extension frame 22. The belt 320 may be disposed on the upper surface 22a of the first extension frame 22, may support the second extension frame 23, and may be rotated by the second motor 310.

The belt 320 may be disposed along the longitudinal direction of the first extension frame 22, and the upper surface of the belt 320 may be in contact with the second extension frame 23. The belt 320 may be supported by a plurality of rollers rotating by the second motor 310, may have a closed loop shape, and may move in an endless orbit.

When the second motor 310 rotates the belt 320, the second extension frame 23 supported by the belt 320 may advance in a direction away from the first extension frame 22.

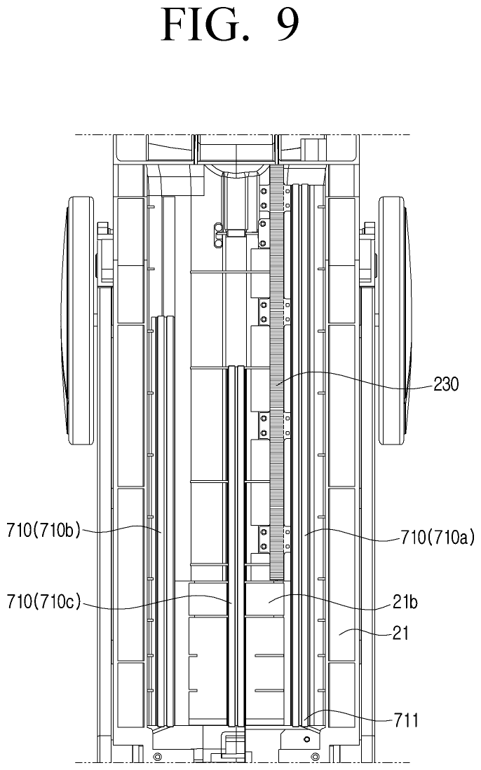

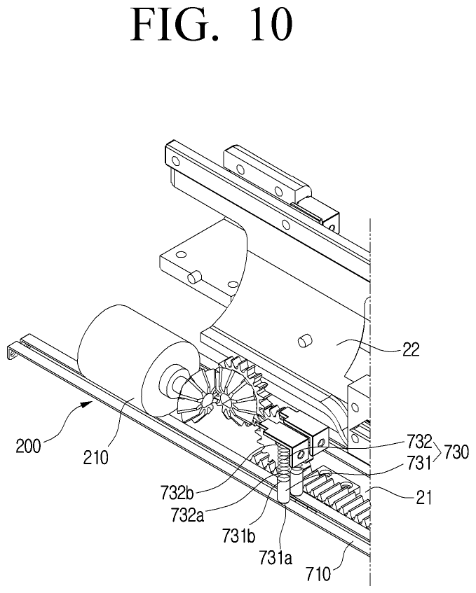

FIG. 9 is a top view of a main frame according to an embodiment of the disclosure. FIG. 10 is a view illustrating a terminal structure for supplying power to a first extension device according to an embodiment of the disclosure. Referring to FIGS. 9 and 10, the robot cleaner 1 may include a rail 710, a wire 720, and a terminal 730.

The rail 710 may be arranged on the upper surface 21b of the main frame 21 in parallel with the longitudinal direction of the main frame 21. The rail 710 may be made of metal and may transmit power received from the wire 720 to the terminal 730.

The rail 710 may be formed as a pair of rails corresponding to an anode and a cathode, respectively. The rail 710 may be formed as a total of three pairs of rails. Each pair of rails 710 may transmit power received from the wire 720 to the first extension device 200, the second extension device 300, and the head part 30. The power transmitted to the second extension device 300 through a first pair of rails 710a may drive the second motor 310, and the power transmitted to the head part 30 through a third pair of rails 710c may drive the mapping sensor 31 disposed on the head part 30.

The wire 720 may provide power to the first extension device 200, and may be electrically connected to the rear end 711 of the rail 710. The wire 720 may electrically connect a power source disposed inside the main body 10 and the rear end 711 of the rail 710. When the robot arm 20 is extended, the length of the wire 720 may not change.

The terminal 730 may electrically connect the rail 710 and the first extension device 200, and may move integrally with the first extension frame 22. Like the rail 710, the terminal 730 may be formed as a pair of terminals corresponding to the anode and the cathode, respectively.

The terminal 730 may be electrically connected to the first motor 210 of the first extension device 200 through an electric wire. Accordingly, when the first motor 210 of the first extension device 200 moves together with the first extension frame 22, the length of the wire 720 does not change and the power may be stably supplied to the first motor 210 through the power source inside the main body 10, the wire 720, the rail 710, and the terminal 730.

The terminal 730 may include a contact terminal 731 and an elastic member 732. The contact terminal 731 may include a lower surface 731a in contact with the rail 710. The elastic member 732 may include one end 732a connected to the upper surface 731b of the contact terminal 731 and the other end 732b connected to the first extension frame 22. The other end 732b of the elastic member 732 may be electrically connected to the first extension device 200.

Accordingly, when the terminal 730 moves together with the first extension frame 22, the elastic member 732 presses the contact terminal 731 downward so that the lower surface 731a of the contact terminal 731 may be continuously in contact with the rail 710, thereby stably supplying power to the first motor 210.

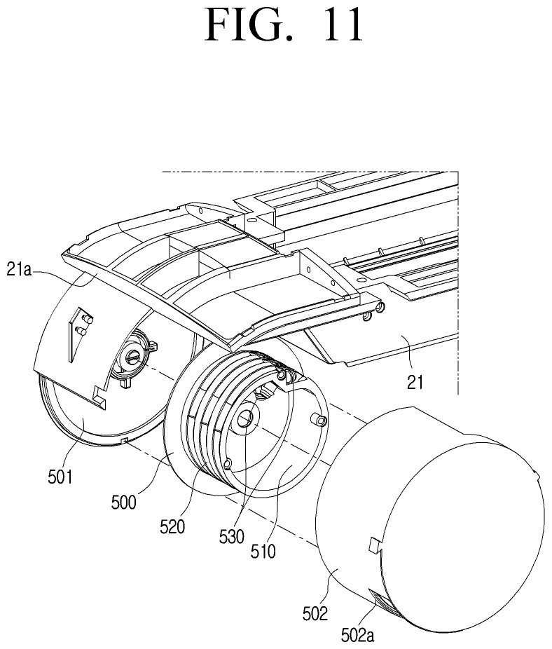

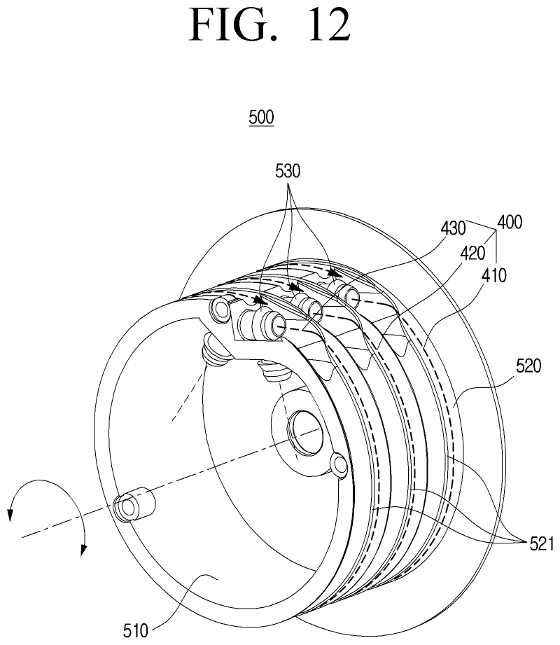

FIGS. 11 and 12 are an exploded perspective view and a perspective view of a drum part, respectively, according to various embodiments of the disclosure. Referring to FIGS. 11 and 12, the robot cleaner 1 may further include a plurality of connection tubes 400 and a drum 500.

The plurality of connection tubes 400 may allow the pump device 40 to communicate with the other ends 102 of the plurality of bending tubes 100, respectively. For example, the plurality of connection tubes 400 may include a first connection tube 410 in communication with the first bending tube 110, a second connection tube 420 in communication with the second bending tube 120, and a third connection tube 430 in communication with the third bending tube 130.

The drum 500 may be rotatably connected to one end 21a of the main frame 21 and the plurality of connection tubes 400. The drum 500 may include a plurality of ports 530 that are formed to communicate an inner circumferential surface 510 of the drum 500 with an outer circumferential surface 520 thereof and through which the plurality of connection tubes 400 pass respectively.

The drum 500 may be rotatably connected to a plate 501 integrally connected to the one end 21a of the main frame 21 and may be surrounded by a cover 502. The drum 500 may have a shape of a circular wall protruding from the plate 501.

The connection tubes 400 may sequentially pass from the main body 10 through the inlet 502a formed on the outer circumferential surface of the cover 502 and the ports 530 of the drum 500, may wrap around the outer circumferential surface 520 of the drum 500 at least one turn, and may be connected to the plurality of bending tubes 100.

One section of the connection tubes 400 may pass through the ports 530 and wrap around the outer circumferential surface 520 of the drum 500. The one section of the connection tubes 400 may wrap around the outer circumferential surface 520 of the drum 500 at least one turn.

When the overall length of the robot arm 20 is increased by the first extension device 200 and the second extension device 300, the head part 30 and the bending tubes 100 may move in a direction away from the rear end of the robot arm 20. At this time, the connection tubes 400 may be pulled by the bending tubes 100 in a direction away from the rear end of the robot arm 20 (the direction of extension of the robot arm 20).

When the connection tubes 400 are pulled, the drum 500 rotates so that one section of the connection tubes 400 wound around the outer circumferential surface 520 of the drum 500 may be released from the drum 500.

Accordingly, when the robot arm 20 is extended so that the overall length of the robot arm 20 is increased, the extra length of the connection tubes 400 is released from the drum 500, so the pressure of the pump device 40 may be stably transmitted to the plurality of bending tubes 100 through the connection tubes 400.

The drum 500 may include a plurality of grooves 521 formed along the circumferential direction on the outer circumferential surface 520 and around which the plurality of connection tubes 400 are wound respectively. Accordingly, the plurality of connection tubes 400 may be wound around or unwound from the outer circumferential surface 520 of the drum 500 while being respectively seated in the plurality of grooves 521.

FIG. 13 is a view schematically illustrating a structure of a pump device according to an embodiment of the disclosure.

Referring to FIG. 13, the pump device 40 may include an air pump 41, an inflow pipe 42, and a discharge pipe 43.

The air pump 41 may suck in air from the atmosphere and compress it. Air compressed by the air pump 41 may move into the internal spaces of the plurality of bending tubes 100 through the inflow pipe 42.

The inflow pipe 42 may connect the air pump 41 and the plurality of bending tubes 100. Accordingly, the air discharged from the air pump 41 moves to the plurality of bending tubes 100 through the inflow pipe 42 so that the pressure in the internal spaces of the plurality of bending tubes 100 may increase.

The discharge pipe 43 may connect the plurality of bending tubes 100 and the outside of the pump device 40. Accordingly, the air in the internal space of the plurality of bending tubes 100 moves to the outside of the pump device 40 through the discharge pipe 43 so that the pressure in the internal spaces of the plurality of bending tubes 100 may be reduced.

The other end of each of the plurality of bending tubes 100 connected to the pump device 40 may be branched into two tubes, and the two tubes may be connected to the inflow pipe 42 and the discharge pipe 43, respectively.

A plurality of first valves 44 may allow the inflow pipe 42 to selectively communicate with the plurality of bending tubes 100, respectively. When the plurality of first valves 44 are opened to allow the inflow pipe 42 to communicate with the plurality of bending tubes 100, the air discharged from the air pump 41 may flow into the plurality of bending tubes 100 through the inflow pipe 42.

When the plurality of first valves 44 are closed so that the inflow pipe 42 does not communicate with the plurality of bending tubes 100, the air discharged from the air pump 41 may not move to the plurality of bending tubes 100 through the inflow pipe 42.

The plurality of first valves 44 may be solenoid valves operated by an electrical signal. However, the type of the first valves 44 is not limited thereto, and the plurality of first valves 44 may be check valves that close when the pressure in the inflow pipe 42 is lower than the pressure in each of the plurality of bending tubes 100.

For example, the plurality of first valves 44 implemented as check valves may prevent air from flowing back from the plurality of bending tubes 100 to the inflow pipe 42 through a simple mechanical structure without being controlled through a separate electrical signal. Accordingly, the processor 600 may not control the first valves 44.

For example, the plurality of first valves 44 may be implemented as one of a swing check valve, a wafer check valve, a disk check valve, a ball check valve, a lift check valve, and a Smorensky check valve.

A plurality of second valves 45 may allow the discharge pipe 43 to selectively communicate with the plurality of bending tubes 100, respectively. When the plurality of second valves 45 are opened to allow the discharge pipe 43 to communicate with the plurality of bending tubes 100, the air in the internal spaces of the plurality of bending tubes 100 may move to the outside of the pump device 40 through the discharge pipe 43.

When the plurality of second valves 45 are closed so that the discharge pipe 43 is not communicated with the plurality of bending tubes 100, the air in the internal spaces of the plurality of bending tubes 100 may not move to the outside of the pump device 40 through the discharge pipe 43. The plurality of second valves 45 may be implemented as solenoid valves.

A plurality of pressure sensors 46 may sense the pressure in the internal spaces of the plurality of bending tubes 100, respectively.

The pressure in the internal space of the first bending tube 110 may be determined by the operation of the first valve 44c, the second valve 45c, and the pressure sensor 46c corresponding to the first bending tube 110. Likewise, the pressure in the internal space of the second bending tube 120 may be determined by the operation of the first valve 44b, the second valve 45b, and the pressure sensor 46b corresponding to the second bending tube 120. In addition, the pressure in the internal space of the third bending tube 130 may be determined by the operation of the first valve 44a, the second valve 45a, and the pressure sensor 46a corresponding to the third bending tube 130.

For example, the processor 600 may first control the air pump 41 to provide compressed air. In addition, the processor 600 may control all of the first valves 44 to be open and all of the second valves 45 to be closed. Accordingly, the plurality of bending tubes 100 may be extended as compressed air from the air pump 41 flows into the internal spaces of the bending tubes 100 through the inflow pipe 42.

At this time, the processor 600 may receive the measured pressure values from the plurality of pressure sensors 46 and identify whether they are the same as a preset pressure valve. When the processor 600 identifies that the measured pressure valves of the plurality of pressure sensors 46 are the same as the preset pressure value, the processor 600 may control both the first and second valves 44 and 45 to close. Accordingly, the plurality of bending tubes 100 may continuously maintain a specific shape.

Thereafter, the processor 600 may control the opening and closing of the first and second valves 44 and 45 based on the measured pressure values of the plurality of pressure sensors 46, thereby adjusting the air inflow amount or the air outflow amount in each of the plurality of bending tubes 100. The plurality of bending tubes 100 may have different shapes as the air inflow amount or air outflow amount is adjusted.

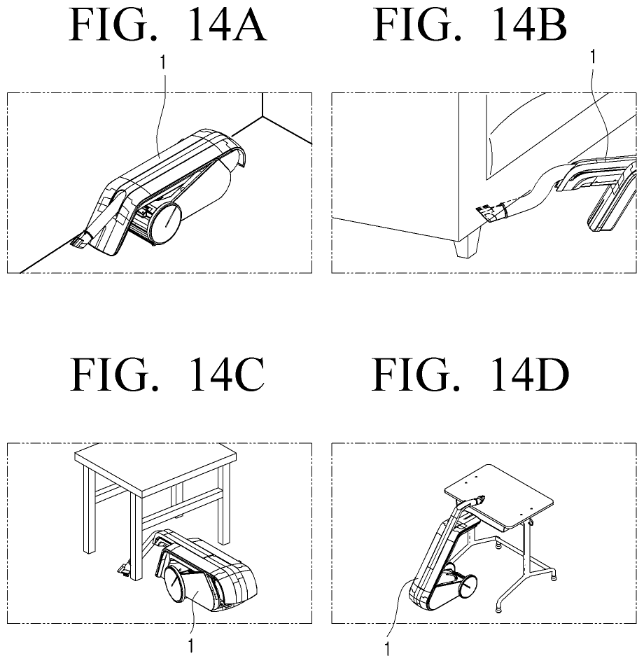

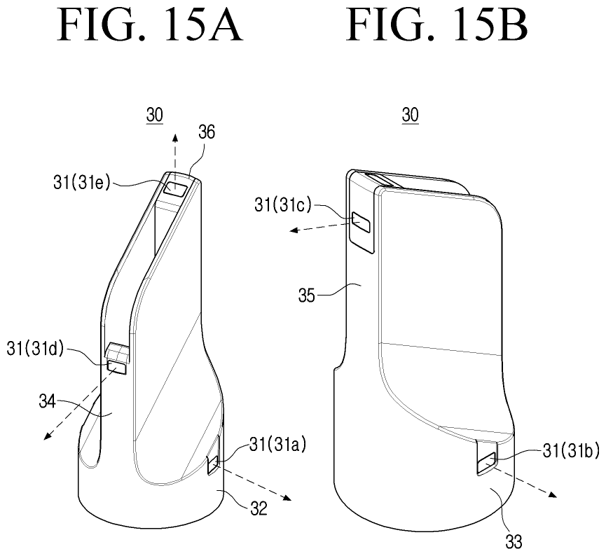

FIGS. 14A, 14B, 14C, and 14D are views illustrating motions of a robot cleaner cleaning various spaces according to an embodiment of the disclosure. FIGS. 15A and 15B are perspective views of a head part according to an embodiment of the disclosure.

Referring to FIG. 14A, the robot cleaner 1 may clean the corner by bending the bending tubes 100 toward the corner to bring the head part 30 into close contact with the corner.

Referring to FIG. 14B, the robot cleaner 1 may clean the narrow space under the sofa by keeping the robot arm 20 in close contact with the floor and extending the robot arm 20.

Referring to FIG. 14C, the robot cleaner 1 may bend the bending tubes 100 and swing the bending tubes 100 left and right to clean the back of the legs of a table or chair, which was difficult for a robot cleaner according to the prior art to enter, without moving the furniture.

Referring to FIG. 14D, the robot cleaner 1 may clean an upper area, such as an upper surface of a high table, by tilting and then extending the robot arm 20.

For example, the robot cleaner 1 may perform cleaning while traveling in a zigzag manner. When the robot cleaner 1 encounters a terrain feature while cleaning, the robot cleaner 1 may use a plurality of sensors located on the main body and the head part to select a cleaning area that the head part may enter, and approach the head part 30 to the selected cleaning area.

In addition, the robot cleaner 1 may control the pump device 40 according to the detection result of the mapping sensor 31 disposed on the head part 30 to appropriately bend or swing the bending tubes 100, thereby moving the head part 30, so that the head part 30 may clean the entire cleaning area without colliding with obstacles within the cleaning area.

Referring to FIGS. 15A and 15B, the mapping sensor 31 may include a plurality of mapping sensors 31 disposed on the left surface 32, a right surface 33, an upper surface 34, and the lower surface 35 of the head part 30, respectively.

The plurality of mapping sensors 31 may include first to fourth mapping sensors 31a, 31b, 31c, and 31d respectively disposed on the left surface 32, the right surface 33, the upper surface 34, and the lower surface 35 of the head part 30. The plurality of mapping sensors 31 may further include a fifth mapping sensor 31e disposed on a front surface 36 of the head part 30.

The plurality of mapping sensors 31 may detect the distance from each surface of the head part 30 to an obstacle in the cleaning area, and the processor 600 may generate a three-dimensional map of the cleaning area into which the head part 30 entered.

Accordingly, the robot cleaner 1 may control the pump device 40 according to the detection result of the mapping sensor 31 disposed on the head part 30 to appropriately bend or swing the bending tubes 100, thereby moving the head part 30 so that the head part 30 may clean the entire cleaning area without colliding with obstacles within the cleaning area.

In addition, the robot cleaner 1 may extend the robot arm 20 two times according to the sensed depth of the cleaning area, and tilt the robot arm 20 according to the height of the cleaning area to position the head part 30 in a deep space or upper area.

For example, in the robot cleaner 1 according to an embodiment of the disclosure, the head part 30 supported by the plurality of flexible bending tubes 100 may clean various types of spaces while having a high degree of freedom.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage such as, for example, a storage device like read only memory (ROM), whether erasable or rewritable or not, or in the form of memory, such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A robot cleaner comprising:
a plurality of bending tubes which are integrally connected along a longitudinal direction thereof and each of which is closed at one end and changes in volume depending on pressure in an internal space thereof;
a pump device that adjusts the pressure in the internal space of each of the plurality of bending tubes;
a head part disposed at one end of the plurality of bending tubes to suck air;
a dust collection device that separates dust from the air sucked through the head part; and
a dust collection tube that communicates the head part and the dust collection device.

2. The robot cleaner of claim 1, further comprising:
a main body accommodating the pump device and the dust collection device;
a robot arm connected to the main body and supporting the plurality of bending tubes and the dust collection tube;
a driving device to move the robot arm;
a camera to capture images of a surrounding environment of the robot cleaner; and
a processor that identifies a cleaning area based on the images captured by the camera and control the driving device to place the head part in the identified cleaning area.

3. The robot cleaner of claim 2, further comprising:
a mapping sensor to detect the cleaning area around the head part; and
a processor that determines a motion of the plurality of bending tubes based on a signal received from the mapping sensor and controls the pump device to bend the plurality of bending tubes in the determined motion.

4. The robot cleaner of claim 3,
wherein the mapping sensor is disposed on the head part and detects a distance between the head part and an obstacle disposed in the cleaning area, and
wherein the processor determines the motion of the plurality of bending tubes based on the distance to the obstacle detected by the mapping sensor.

5. The robot cleaner of claim 1, further comprising:
a main body accommodating the pump device and the dust collection device; and
a robot arm rotatably connected to the main body and supporting the plurality of bending tubes and the dust collection tube.

6. The robot cleaner of claim 5, wherein the robot arm comprises:
a main frame including one end rotatably connected to the main body; and
a first extension frame that supports the plurality of bending tubes and is connected to the main frame so as to be movable along a longitudinal direction of the main frame.

7. The robot cleaner of claim 6, wherein the first extension frame is slidingly connected to an upper surface of the main frame and is disposed below the plurality of bending tubes to support the plurality of bending tubes upward.

8. The robot cleaner of claim 7, further comprising:
a first extension device that moves the first extension frame along the longitudinal direction of the main frame.

9. The robot cleaner of claim 8, wherein the first extension device comprises:
a first motor connected to the first extension frame;
a pinion gear rotated by the first motor; and
a rack gear engaged with the pinion gear and disposed on the upper surface of the main frame.

10. The robot cleaner of claim 8, further comprising:
a rail disposed on the upper surface of the main frame parallel to the longitudinal direction of the main frame;
a wire that provides power to the first extension device and is electrically connected to a rear end of the rail; and
a terminal electrically connecting the rail and the first extension device and moving integrally with the first extension frame.

11. The robot cleaner of claim 6, wherein the robot arm further comprises:
a second extension frame that supports another end of the plurality of bending tubes and is connected to the first extension frame so as to be movable along a longitudinal direction of the first extension frame.

12. The robot cleaner of claim 11, further comprising:
a plurality of connection tubes that communicates the pump device with the plurality of bending tubes, respectively,
wherein the second extension frame is slidingly connected to an upper surface of the first extension frame, supports the another end of the plurality of bending tubes, and includes a plurality of holes through which the plurality of connection tubes each pass.

13. The robot cleaner of claim 12, further comprising:
a second extension device that moves the second extension frame along the longitudinal direction of the first extension frame.

14. The robot cleaner of claim 13, wherein the second extension device comprises:
a second motor connected to the first extension frame; and
a belt disposed on the upper surface of the first extension frame, supporting the second extension frame, and being rotated by the second motor.

15. The robot cleaner of claim 6, further comprising:
a plurality of connection tubes that communicates the pump device with other ends of the plurality of bending tubes, respectively; and
a drum rotatably connected to one end of the main frame and including a plurality of ports that communicates an inner circumferential surface of the drum with an outer circumferential surface of the drum and through which the plurality of connection tubes each pass,
wherein one sections of the connection tubes pass through the ports and wraps around the outer circumferential surface of the drum.
